(19) United States
(12) Patent Application Publication
(10) Pub. No.: US 2026/0367016 A1
(43) Pub. Date: Nov. 19, 2026

(54) METHOD AND APPARATUS FOR DETERMINING MATERIAL PARAMETERS

(71) Applicant: TRILITEC GmbH, Bremen (DE)

(72) Inventor: Benjamin LITTAU, Oyten (DE)

(73) Assignee: TRILITEC GmbH, Bremen (DE)

(21) Appl. No.: 19/674,844

(22) Filed: May 12, 2026

(30) Foreign Application Priority Data
May 14, 2025 (DE) 10 2025 118 510.7

(51) Int. Cl. G01N 22/00; G01B 7/14; G01B 11/02; G01B 11/06; G01B 15/02; G01B 17/02; G01S 13/08; G01S 15/08; G01S 17/08

(52) U.S. Cl. CPC G01N 22/00; G01B 11/026; G01S 13/08; G01S 15/08; G01S 17/08; G01B 7/14; G01B 11/06; G01B 15/02; G01B 17/02

(57) ABSTRACT

The invention relates to a method for in particular automatically determining at least one material parameter, preferably at least two material parameters, in particular the thickness and/or the density and/or the refractive index or some other material parameter, of a preferably elongate measurement object (11), in which, preferably within a superordinate production process in which the measurement object (11) is produced or used, radar waves are directed by means of a radar transmitter onto the measurement object (11) arranged between a reference surface (13) and the radar transmitter, said radar waves passing through the measurement object (11) and then impinging on the reference surface (13), in which the optical path length OWL between radar transmitter and reference surface (13) is measured by means of the radar waves, and in which, in particular by means of an evaluation device, the material parameter to be determined of the measurement object (11) is ascertained on the basis of the measured optical path length OWL, the distance a between the radar transmitter and a boundary surface of the measurement object (11) which faces the radar transmitter and on which the radar waves impinge upon entrance into the measurement object (11), the distance b between a boundary surface of the measurement object (11) which faces the reference surface (13) and from which the radar waves emerge after passing through said measurement object and the reference surface (13), and the distance RD between the radar transmitter and the reference surface (13).

The present invention relates to a method and an apparatus for in particular automatically determining at least one material parameter, preferably at least two material parameters, of a preferably elongate measurement object, in particular the thickness and/or the density and/or the refractive index and/or some other material parameter.

In quality assurance in the production of products, preliminary products, etc., in the prior art sampling of the respective measurement object used or produced in the context of production and laboratory testing are often required in order to determine material parameters of the measurement object. Such a measurement object may be for example an insulating material web that has been produced or is still being produced. In the case of such insulating material webs, for example, a spot check is carried out in this way to establish whether the thickness of the insulating material webs just produced corresponds to predefined target values. However, this approach is time-and personnel-intensive and prone to process errors.

In the prior art, laser sensors are also used to measure material thicknesses of measurement objects. However, these are unsuitable for example for partially transparent or rough-surface materials, for instance polymer foams.

X-ray-based systems are also used to determine the density of measurement objects. However, because of the necessary shielding measures for larger measurement objects these systems are impractical and unsuitable even for very low density, as occurs for example in lightweight construction.

Taking this as a departure point, it is an object of the present invention to specify a particularly reliable method, which can be used as necessary even during an ongoing production process, for in particular automatically determining at least one material parameter of a measurement object. It is furthermore an object of the invention to specify a measuring apparatus suitable therefor.

This object is achieved by a method having the features of claim 1 and by a measuring apparatus having the features of claim 15.

The method according to the invention accordingly comprises the procedure that, preferably within a superordinate production process in which the measurement object is produced or used, radar waves (or electromagnetic waves in the radar wavelength range) are directed by means of a radar transmitter onto the measurement object arranged between a reference surface and the radar transmitter, said radar waves passing through the measurement object and then impinging on the reference surface, wherein the optical path length OWL between radar transmitter and reference surface is measured by means of the radar waves, and wherein, in particular by means of an evaluation device, the material parameter to be determined of the measurement object is ascertained on the basis of the measured optical path length OWL and also on the basis of the distance a between the radar transmitter and a boundary surface of the measurement object which faces the radar transmitter and on which the radar waves impinge upon entrance into the measurement object, on the basis of the distance b between a boundary surface of the measurement object which faces the reference surface and from which the radar waves emerge after passing through the measurement object and the reference surface, and on the basis of the (actual) distance RD between the radar transmitter and the reference surface.

It has been found that material parameters such as the thickness and/or the density and/or the refractive index of a measurement object can be determined without any problems and reliably with this method, specifically as necessary even during the superordinate production process. The measurement object can preferably be a measurement object made of lightweight construction materials (insulating material or foam or the like) or wood material.

Provision can preferably be made for the distance a and/or the distance b and/or the distance RD also to be determined by measurement, in particular by a measurement before the ascertainment of the material parameter by the evaluation device. However, it is conceivable here that one of these distances has the value zero and for this reason does not have to be explicitly measured in practise. By way of example, the distance b could have the value zero if the measurement object bears directly against the reference surface.

Preferably, provision can furthermore be made for the or one of the material parameters determined in the context of the method to be a (geometric) dimension D of the measurement object, in particular the thickness thereof, and/or the density of the measurement object and/or the refractive index ME of the measurement object, wherein, in the context of determining the dimension D and/or the density and/or the refractive index ME, the relationship OWL=a+b+D*ME and/or the relationship RD=a+b+D are/is used.

Furthermore, provision can preferably be made for the distance a to be measured by means of electromagnetic waves, in particular radar waves or laser light, reflected by the boundary surface of the measurement object facing the radar transmitter or by means of ultrasonic waves which have been directed onto the measurement object beforehand, and/or for the distance b to be measured by means of electromagnetic waves, in particular radar waves or laser waves, reflected by the boundary surface of the measurement object facing the reference surface or by means of ultrasonic waves which have been directed onto the measurement object beforehand, and/or for the distance RD to be measured by means of electromagnetic waves, in particular radar waves or laser waves, or by means of ultrasonic waves which have been directed onto the reference surface beforehand, in particular by means of such waves which have been reflected by the reference surface.

In this case, provision can additionally be made for the optical path length OWL and/or the distance a and/or the distance b to be measured by means of the radar waves originating from the radar transmitter. Alternatively, provision can also be made for the optical path length OWL to be measured by means of the radar waves originating from the radar transmitter and the distance a and/or the distance b and/or the distance RD to be measured by means of laser light of one or more laser transmitters or by means of radar waves of one or more further radar transmitters or by means of ultrasonic waves of one or more ultrasonic transmitters.

In this case, the laser transmitter or the ultrasonic transmitter or the further radar transmitter which respectively directs the laser light or the ultrasonic waves or the radar waves for measuring the distance a onto the boundary surface facing the radar transmitter is arranged adjacent to the radar transmitter on the same side of the measurement object as the radar transmitter, and/or the laser transmitter or the ultrasonic transmitter or the further radar transmitter which respectively directs the laser light or the ultrasonic waves or the radar waves for measuring the distance b onto the boundary surface facing the reference surface is arranged adjacent to the reference surface on the same side of the measurement object as the reference surface.

The radar waves for measuring the distance a and/or b and/or RD and/or the optical path length OWL can preferably be radar waves in the range of between 0.3 GHZ and 1000 GHZ.

Furthermore, provision can be made for the radar waves for measuring the optical path length OWL to be radar waves of lower frequency, in particular in the range of between 1 GHz and 80 GHz, preferably between 1 and 67 GHz, and the radar waves for measuring the distance a and/or b and/or RD to be radar waves of higher frequency, in particular in the range of between 40 GHz and 300 GHz, preferably between 50 GHz and 260 GHz.

With regard to the distance a and/or b and/or RD and/or the optical path length OWL, same can preferably be measured by means of an FMCW radar measurement method or by means of an AMCW radar measurement method.

Preferably, provision can furthermore be made, in the context of the measurement of the distance a and/or b and/or RD and/or the optical path length OWL, for frequency-or amplitude-modulated radar wave signals to be generated by the radar transmitter or the one further or each further radar transmitter and to be received by a radar receiver after reflection by the (respective) boundary surface of the measurement object or the reference surface, and for the distances a and/or b and/or RD and/or the optical path length OWL to be ascertained on the basis of the frequency or amplitude shift between the generated and the received signals.

In this case, the radar receiver forming a radar sensor unit in particular together with the radar transmitter can be arranged on the same side of the measurement object as the radar transmitter or the further radar transmitter.

In accordance with a further, particularly preferred development of the invention, provision can be made such that, in order to compensate for influences of the measurement environment, in particular an unwanted, for example temperature-related, change in position of the radar transmitter and/or of the reference surface, the current actual distance RD is measured repeatedly, in particular periodically or continuously, during the method (or optionally the production process), and that the respectively measured actual distance RD is used in the context of the ascertainment of the or each material parameter to be determined.

Generally speaking, provision can be made for the distance a and/or b and/or RD and/or the optical path length OWL to be measured repeatedly, in particular periodically, and for the measured values in the context of the determination of the or each material parameter to compensate for influences of the measurement environment that would lead to an incorrect determination of the or each material parameter, in particular a change in the distance a and/or b and/or RD and/or the optical path length OWL based on an unwanted, for example temperature-related, change in position of the radar transmitter and/or of the reference surface.

With regard to the measurement object, the measurement object, preferably a material strand, in particular composed of foam, insulating material or wood material, for determining the respective material parameter at different positions of the measurement object, can be conveyed along at a measuring apparatus which carries out the method and has in particular the radar device and/or the evaluation device and optionally the additional distance measuring apparatus, in particular within the superordinate production process, wherein the measuring apparatus carries out the determination of the material parameter at the different positions of the measurement object by virtue of the measuring apparatus carrying out the measurements required for this purpose in each case successively at these different positions.

The measuring apparatus according to the invention can be configured in particular for carrying out the method of the abovementioned method. It has a radar device for measuring the optical path length OWL between a reference surface and a radar transmitter of the radar device, by means of which radar waves can be directed onto the measurement object arranged between the transmitter and the reference surface, said radar waves passing through the measurement object and then impinging on the reference surface, wherein by means of the radar device for measuring the optical path length OWL and/or by means of an additional distance measuring device it is possible to measure the distance a between the radar transmitter of the radar device and a boundary surface of the measurement object which faces the radar transmitter and on which the radar waves impinge upon entrance into the measurement object, and/or the distance b between a boundary surface of the measurement object which faces the reference surface and from which the radar waves emerge after passing through the measurement object and the reference surface, and/or the distance RD between the radar transmitter of the radar device and the reference surface, and wherein the measuring apparatus has an evaluation device, by means of which the material parameter to be determined of the measurement object can be ascertained on the basis of the distances a and b and RD and the measured optical path length OWL.

In this case, the radar device for measuring the optical path length OWL and/or the distance measuring device can be an FMCW radar device or an AMCW radar device. Alternatively or additionally, the distance measuring device can be a laser sensor device with at least one laser transmitter and at least one laser receiver or an ultrasonic sensor device with at least one ultrasonic transmitter and at least one ultrasonic receiver.

The radar device for measuring the optical path length OWL can have a radar receiver, in particular a radar receiver arranged on the same side of the measurement object as the radar transmitter of the radar device.

The distance measuring device can have two sensor units each having a transmitter and a receiver, in particular a laser or ultrasonic transmitter and a laser or ultrasonic receiver, wherein one sensor unit for measuring the distance a is arranged on the side of the measurement object on which the radar transmitter of the radar device for measuring the optical path length OWL is arranged, such that said one sensor unit can direct measurement waves, in particular radar waves, laser light or ultrasonic waves, onto the boundary surface of the measurement object facing the radar transmitter of the radar device for measuring the optical path length OWL and can receive measurement waves reflected therefrom, and wherein the other sensor unit for measuring the distance b is arranged on the other side of the measurement object, on which the reference surface is situated, such that the other sensor unit can direct measurement waves onto the boundary surface of the measurement object facing the reference surface and can receive measurement waves reflected therefrom.

With regard to the distance measuring device, it can alternatively also have two radar sensor units each having a radar transmitter and a radar receiver, wherein the one radar sensor unit for measuring the distance a is arranged on the side of the measurement object on which the radar transmitter of the radar device for measuring the optical path length OWL is arranged, such that it can direct radar waves onto the boundary surface of the measurement object facing the radar transmitter of the radar device for measuring the optical path length OWL and can receive radar waves reflected therefrom, and wherein the other radar sensor unit for measuring the distance b is arranged on the other side of the measurement object, on which the reference surface is situated, such that it can direct radar waves onto the boundary surface of the measurement object facing the reference surface and can receive radar waves reflected therefrom.

Further features of the present invention are evident from the appended patent claims, from the following description of preferred exemplary embodiments, and from the appended drawings, in which:

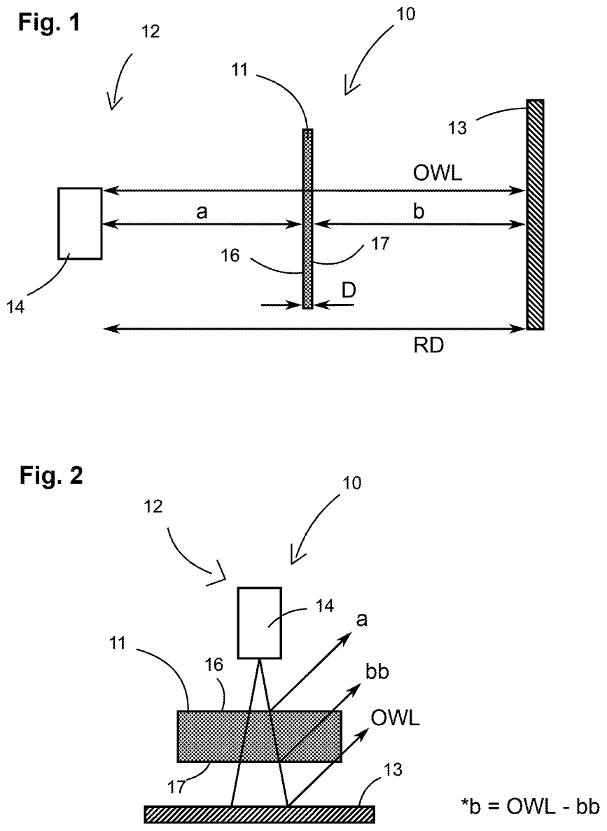

FIG. 1 shows a simplified plan view of a first embodiment of the measuring apparatus according to the invention,

FIG. 2 shows a side view of the measuring apparatus from FIG. 1,

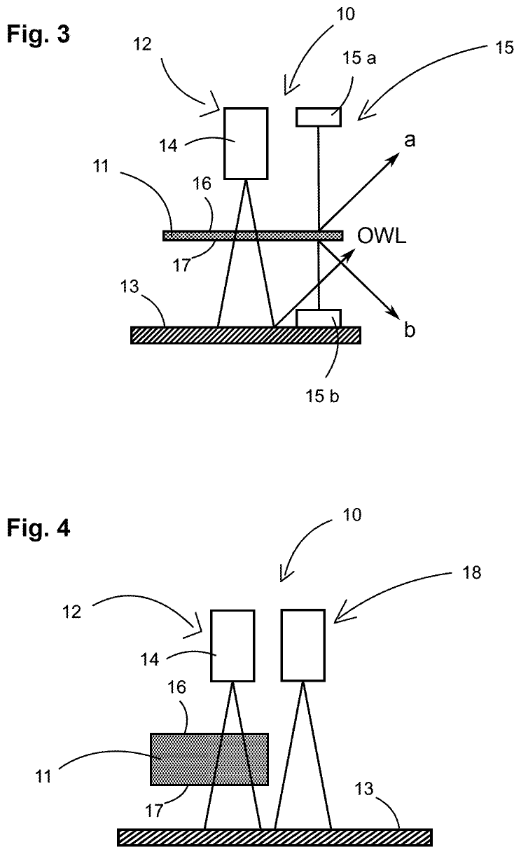

FIG. 3 shows a side view of a second embodiment of the measuring apparatus according to the invention,

FIG. 4 shows a side view of a third embodiment of the measuring apparatus according to the invention,

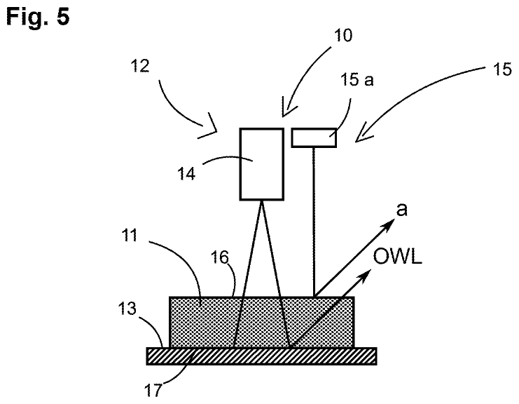

FIG. 5 shows a side view of a fourth embodiment of the measuring apparatus according to the invention.

The measuring apparatus 10 shown in the drawings serves to determine one or more material parameters of a measurement object 11, which is elongate in the present case, within the production process of the measurement object 11. The measurement object 11 can be for example a material strand, for instance made of insulating material, foam or wood material. However, it goes without saying that the present invention could also be used to capture material parameters of entirely different measurement objects, specifically also outside a production process.

In the present case, the measurement object 11 is moved past the measuring apparatus 10 continuously or cyclically during the measurement, such that the measuring apparatus 10 can carry out measurements at different positions of the measurement object 11. In this way, the respective material parameter of the measurement object 11 can be measured repeatedly, in particular continuously or periodically, during the entire production process and monitored in this way.

The respective measurement can be carried out while the measuring apparatus 10 is at a standstill relative to the measurement object 11 or alternatively while these are moving relative to one another.

As can be discerned in FIG. 1, the measurement object 11 is situated between a radar device 12 of the measuring apparatus 10 and a reference surface 13 of the measuring apparatus 10.

In the case of FIG. 1, the radar device 12 comprises a radar sensor unit 14 having a radar transmitter and a radar receiver, both of which are arranged on the side of the measurement object 11 that faces away from the reference surface 13. The radar sensor unit 14 can be an FMCW sensor unit or an AMCW sensor unit, which is accordingly based on these known techniques.

In the present case, the method according to the invention is intended to determine a geometric dimension of the measurement object 11, specifically the thickness D thereof, and additionally the refractive index ME of the measurement object 11. Other geometric dimensions of a measurement object or other material parameters could also be determined. By way of example, after determining the thickness D and the refractive index ME, the density of the measurement object 11 or of the material of which it consists could be determined, for instance by using tables linking the thickness D and/or the refractive index to these further material parameters, and/or by using suitable formulae.

In the context of the embodiment in FIGS. 1 and 2, the radar device 12 or the radar transmitter of the radar device 12 transmits radar waves to or in the direction of the measurement object 11, which radar waves at least partially penetrate through the latter, are then reflected back in the direction of the measurement object 11 by the preferably metallic reference surface 13, at least partially penetrate through the measurement object again in the opposite direction and are finally detected by the radar receiver of the radar sensor unit 14.

In this case, the radar device 12 allows continuous or periodic determination of important distances/dimensions or values for the method according to the invention in the superordinate production process, preferably by means of methods known per se, such as the FMCW radar measurement method or the AMCW radar measurement method. The frequencies of the radar waves used (which by their nature are electromagnetic) preferably range between 0.3 GHZ and 1000 GHz.

The measurement values determined in this way are firstly the optical path length OWL between the radar transmitter and the reference surface 13, furthermore the distance a between the radar transmitter and the measurement object 11 and the distance b between the measurement object 11 and the reference surface 13, cf. FIG. 1.

In this case, the distance a is measured continuously or periodically by means of radar waves which have been directed onto the measurement object 11 beforehand and which are reflected by the boundary surface 16 of the measurement object 11 facing the radar transmitter of the radar device 12.

The distance b is measured continuously or periodically by means of radar waves which have been directed onto the measurement object 11 beforehand and which are reflected by the boundary surface 17 of the measurement object 11 facing the reference surface 13, wherein the distance b results from the difference between the distance OWL and b, cf. FIG. 2.

As shown in FIG. 3, the distances a and b could alternatively also be measured by means of a separate or additional distance measuring device 15. The distance measuring device 15 can have for example two sensor units 15a and 15b, each having a transmitter and a receiver, in particular having a radar, laser or ultrasonic transmitter and a radar, laser or ultrasonic receiver.

For measuring the distance a, the one sensor unit 15a can then be arranged on the side of the measurement object 11 on which the radar transmitter of the radar device 12 for measuring the optical path length OWL is arranged, such that the sensor unit 15a can direct measurement waves, in particular radar waves, laser light or ultrasonic waves, onto the boundary surface 16 of the measurement object 11 facing the radar transmitter of the radar device 12 for measuring the optical path length OWL and can receive measurement waves reflected therefrom.

For measuring the distance b, the other sensor unit 15b can then be arranged on the other side of the measurement object 11, on which the reference surface 13 is situated, such that the other sensor unit 15b can direct measurement waves onto the boundary surface 17 of the measurement object 11 facing the reference surface 13 and can receive measurement waves reflected therefrom.

As shown in FIG. 5, it is alternatively also conceivable that the distance b does not have to be explicitly measured, for example if the distance b is obviously zero because the measurement object 11 bears directly against the reference surface 13. Accordingly, in contrast to the embodiment in FIG. 3, the second sensor unit 15b of the distance measuring device 15 can be dispensed with in the embodiment in FIG. 5.

With regard to the (actual) distance RD between the radar transmitter and the reference surface 13, it is assumed to be known in the embodiments in FIGS. 1, 2, 3 and 5 and may for example have already been ascertained manually or automatically by means of a suitable measuring device before the production process in the context of the installation of the measuring apparatus 10.

However, it is also conceivable to ascertain or measure the real distance RD within the production process by means of an additional distance measuring device 18, cf. FIG. 4, which for example is likewise based on radar technology or alternatively on laser technology or ultrasonic technology. This device must naturally be arranged such that its measurement waves are directed past the measurement object 11 and impinge directly on the reference surface 13 without having to pass through the measurement object 11 beforehand.

This further distance measuring device 18 can likewise be a radar device. Alternatively, however, it too can be based for example on laser measurement technology or on ultrasonic measurement technology.

On the basis of the aforementioned values a, b, OWL and RD, it is then possible according to the invention for an evaluation device of the measuring apparatus 10, for instance a computer device of the measuring apparatus 10, to which these values are communicated, to determine the thickness D and/or the refractive index ME of the measurement object 11 with the aid of the interrelationships represented in the following two equations I and II:

OWL=a+b+D*ME I)

Rd=a+B+D II)

However, it is also conceivable for example not to ascertain the thickness D by means of or on the basis of the distances measured by the radar device 12, but rather to measure said thickness separately, for instance by means of mechanical probes. Then, in the context of the method according to the invention, (only) the refractive index ME would be ascertained in the first step by means of the thickness D thus detected and the values a and b and also the optical path length OWL.

The density of the measurement object 11 or of the material of the measurement object 11 could then also be determined by means of the thickness D and/or the refractive index ME and further data associated with the thickness and/or the refractive index ME, in particular data stored in one or more tables, the data having been ascertained empirically beforehand.

In accordance with an important special feature of the invention, provision can additionally be made for an inline calibration to be carried out automatically in the context of the method according to the invention, in order for example to compensate for or correct disturbances which arise as a result of environmental influences and which would otherwise falsify the results ascertained in the context of the determination of the material parameters. That is to say specifically environmental influences which would lead to an incorrect determination of the thickness D and/or of the refractive index ME, etc.

By way of example, temperature fluctuations at the location of the measuring apparatus 10 could lead to the distance RD changing inadvertently. In order to compensate for this, provision can be made, by means of the distance measuring device 18 in FIG. 3, for repeatedly, in particular periodically or continuously, measuring the distance RD in the production process and then accordingly using the current actual value of RD in each case in the context of the determination of the thickness D and/or of the refractive index ME and/or of the density, etc.

In a similar manner, the distances a and/or b and/or the thickness and/or OWL can also be measured repeatedly, in particular periodically or continuously, in order to compensate for disturbances.

### LIST OF REFERENCE SIGNS

10 Measuring apparatus
11 Measurement object
12 Radar device
13 Reference surface
14 Radar sensor unit
15 Distance measuring device
15a Sensor unit
15b Sensor unit
16 Boundary surface
17 Boundary surface
18 Distance measuring device

1. A method for automatically determining at least one material parameter of a measurement object, in which, radar waves are directed by means of a radar transmitter onto the measurement object arranged between a reference surface and the radar transmitter, the radar waves passing through the measurement object and then impinging on the reference surface in which the optical path length OWL between radar transmitter and reference surface is measured by means of the radar waves, and in which, the material parameter to be determined of the measurement object is ascertained on the basis of the measured optical path length OWL, the distance a between the radar transmitter and a boundary surface of the measurement object which faces the radar transmitter and on which the radar waves impinge upon entrance into the measurement object the distance b between a boundary surface of the measurement object which faces the reference surface and from which the radar waves emerge after passing through the measurement object and the reference surface, and the distance RD between the radar transmitter and the reference surface.

2. The method as claimed in claim 1, wherein the distance a and/or the distance b and/or the distance RD are/is determined or measured.

3. The method as claimed in claim 1, wherein the distance a is measured by means of electromagnetic waves reflected by the boundary surface of the measurement object facing the radar transmitter or by means of ultrasonic waves which have been directed onto the measurement object beforehand, and/or wherein the distance b is measured by means of electromagnetic waves reflected by the boundary surface of the measurement object facing the reference surface or by means of ultrasonic waves which have been directed onto the measurement object beforehand, and/or wherein the distance RD is measured by means of electromagnetic waves, or by means of ultrasonic waves which have been directed onto the reference surface beforehand.

4. The method as claimed in claim 3, wherein the optical path length OWL and/or the distance a and/or the distance b are/is measured by means of the radar waves originating from the radar transmitter, or wherein the optical path length OWL is measured by means of the radar waves originating from the radar transmitter and the distance a and/or the distance b and/or the distance RD are/is measured by means of laser light of one or more laser transmitters or by means of radar waves of one or more further radar transmitters or by means of ultrasonic waves of one or more ultrasonic transmitters.

5. The method as claimed in claim 4, wherein the radar waves for measuring the optical path length OWL are radar waves of lower frequency and the radar waves for measuring the distance a and/or b and/or RD are radar waves of higher frequency.

6. The method as claimed in claim 1, wherein the radar waves for measuring the distance a and/or b and/or RD and/or the optical path length OWL are radar waves in the range of between 0.3 GHZ and 1000 GHz.

7. The method as claimed in claim 1, wherein the distance a and/or b and/or RD and/or the optical path length OWL are/is measured by means of an FMCW radar measurement method or by means of an AMCW radar measurement method.

8. The method as claimed in claim 7, wherein, in the context of the measurement of the distance a and/or b and/or RD and/or the optical path length OWL, frequency-or amplitude-modulated radar wave signals are generated by the radar transmitter or the one further or each further radar transmitter and are received by a radar receiver after reflection by the (respective) boundary surface of the measurement object or the reference surface, and wherein the distances a and/or b and/or RD and/or the optical path length OWL are/is ascertained on the basis of the frequency or amplitude shift between the generated and the received signals.

9. The method as claimed in claim 1, wherein, in order to compensate for influences of the measurement environment that would lead to an incorrect determination of the or each material parameter, the current distance RD is measured repeatedly, during the method, and wherein this respectively measured distance RD is used in the context of the ascertainment of the or each material parameter to be determined.

10. The method as claimed in claim 1, wherein the current distance a and/or b and/or RD and/or the optical path length OWL are/is measured repeatedly, and wherein the measured values in the context of the determination of the or each material parameter compensate for influences of the measurement environment that would lead to an incorrect determination of the or each material parameter.

11. The method as claimed in claim 8, wherein the radar receiver forming a radar sensor unit is arranged on the same side of the measurement object as the radar transmitter or the further radar transmitter.

12. The method as claimed in claim 4, wherein the laser transmitter or the ultrasonic transmitter or the further radar transmitter which respectively directs the laser light or the ultrasonic waves or the radar waves for measuring the distance a onto the boundary surface facing the radar transmitter is arranged adjacent to the radar transmitter on the same side of the measurement object as the radar transmitter, and/or wherein the laser transmitter or the ultrasonic transmitter or the further radar transmitter which respectively directs the laser light or the ultrasonic waves or the radar waves for measuring the distance b onto the boundary surface facing the reference surface is arranged adjacent to the reference surface on the same side of the measurement object as the reference surface.

13. The method as claimed in claim 1, wherein the or one of the material parameters determined in the context of the method is a (geometric) dimension D of the measurement object, wherein, in the context of determining the dimension D and/or the density and/or the refractive index ME, the relationship OWL=a+b+D*ME and/or the relationship RD=a+b+D are/is used.

14. The method as claimed in claim 1, wherein the measurement object, for determining the material parameter at different positions of the measurement object at a measuring apparatus which carries out the method and has in particular the radar device and/or the evaluation device and optionally the additional distance measuring apparatus, is moved past the measuring apparatus relative to the latter, and wherein the measuring apparatus carries out the determination of the material parameter at different positions of the measurement object by virtue of the measuring apparatus carrying out the measurements required for this purpose in each case successively at these different positions.

15. A measuring apparatus for determining at least one material parameter, of a measurement object for carrying out the method as claimed in claim 1, comprising a radar device for measuring the optical path length OWL between a reference surface and a radar transmitter of the radar device, by means of which radar waves can be directed onto the measurement object arranged between the transmitter and the reference surface, the radar waves passing through the measurement object and then impinging on the reference surface, wherein by means of the radar device for measuring the optical path length OWL and/or by means of an additional distance measuring device it is possible to measure the distance a between the radar transmitter of the radar device and a boundary surface of the measurement object which faces the radar transmitter and on which the radar waves impinge upon entrance into the measurement object, and/or the distance b between a boundary surface of the measurement object which faces the reference surface and from which the radar waves emerge after passing through the measurement object and the reference surface and/or the distance RD between the radar transmitter of the radar device and the reference surface, and wherein the measuring apparatus has an evaluation device, by means of which the material parameter to be determined of the measurement object can be ascertained on the basis of the distances a and b and RD and the measured optical path length OWL.

16. The measuring apparatus as claimed in claim 15, wherein the radar device for measuring the optical path length OWL and/or the distance measuring device are/is an FMCW radar device or an AMCW radar device, and/or wherein the distance measuring device is a laser sensor device with at least one laser transmitter and at least one laser receiver or an ultrasonic sensor device with at least one ultrasonic transmitter and at least one ultrasonic receiver.

17. The measuring apparatus as claimed in claim 15, wherein the radar device for measuring the optical path length OWL has a radar receiver.

18. The measuring apparatus as claimed in claim 15, wherein the distance measuring device has two sensor units each having a transmitter and a receiver, wherein one sensor unit for measuring the distance a is arranged on the side of the measurement object on which the radar transmitter of the radar device for measuring the optical path length OWL is arranged, such that the one sensor unit can direct measurement waves onto the boundary surface of the measurement object facing the radar transmitter of the radar device for measuring the optical path length OWL and can receive measurement waves reflected therefrom, and wherein the other sensor unit for measuring the distance b is arranged on the other side of the measurement object, on which the reference surface is situated, such that the other sensor unit can direct measurement waves onto the boundary surface of the measurement object facing the reference surface and can receive measurement waves reflected therefrom.
